(19) United States
(12) Patent Application Publication
(10) Pub. No.: US 2023/0284629 A1
(43) Pub. Date: Sep. 14, 2023

(54) ANTIMICROBIAL AND ANTIVIRAL TREATMENTS OF MATERIALS

(71) Applicants: THE TRUSTEES OF PRINCETON UNIVERSITY, Princeton, NJ (US); ORTHOBOND CORPORATION, Monmouth Junction, NJ (US)

(72) Inventors: Jeffrey Schwartz, Princeton, NJ (US); Carlos E. Caicedo-Carvajal, Kendall Park, NJ (US); Gregorg E. Lutz, Pennington, NJ (US); Siyang Yang, Princeton, NJ (US)

(73) Assignees: THE TRUSTEES OF PRINCETON UNIVERSITY, Princeton, NJ (US); ORTHOBOND CORPORATION, Monmouth Junction, NJ (US)

(21) Appl. No.: 18/247,028

(22) PCT Filed: Sep. 28, 2021
(86) PCT No.: PCT/US21/71619

§ 371 Date: Mar. 28, 2023

Related U.S. Application Data
(60) Provisional application No. 63/084,253, filed on Sep. 28, 2020.

(51) Int. Cl. A01N 59/20; A01N 25/34; A01N 59/16; A01P 1/00

(52) U.S. Cl. CPC A01N 59/20; A01N 25/34; A01N 59/16; A01P 1/00

(57) ABSTRACT

Disclosed are methods of forming an antimicrobial and/or antiviral metal coating on a substrate comprising surface groups that bond to a metal alkoxide to form a 3-dimensional metal oxide/alkoxide adhesion layer. The methods include A) soaking or spraying a substrate comprising a 3-dimensional metal oxide/alkoxide layer with a solution of a transition metal salt, and reduction of the transition metal salt to form a continuous network of transition metal within the 3-D layer, or B) soaking or spraying a substrate comprising a 3-dimensional metal oxide/alkoxide layer with a solution of a post-transition metal salt, sintering at high temperature to form a continuous post-transition metal network within the 3-D layer, and electrolyzing to replace post-transition metal with a transition metal.

### CROSS-REFERENCE TO RELATED APPLICATIONS

This application claims priority under 35 U.S.C. § 119(e) to U.S. Provisional Patent Application Ser. No. 63/084,253, filed on Sep. 28, 2020, which is hereby incorporated by reference in its entirety.

### FIELD OF THE INVENTION

The present invention is related to the field of antimicrobial, antibacterial and/or antiviral coatings and methods that produce such coatings on surfaces. Such coatings and surfaces find utility in various fields, such as implantable medical devices.

### BACKGROUND

The need to control microorganisms that impact both human health and human industry is a universal concern, with stakeholders from public health officials, hospitals and other healthcare environments, public and private buildings, and private citizens. Typically, control of these organisms can be achieved by the topical application of disinfectants, antiseptics, antibacterials and similar substances to surfaces likely to be contacted by infectious or deleterious organisms, particularly regarding high touch surfaces and medical devices. However, common disinfectants only have a short-term effect and need to be reapplied constantly. This constant cleaning can be onerous, transient, and harmful to the underlying base material.

There is a need for anti-infective surfaces that may be employed in locations particularly susceptible to the colonization and transmission of infectious agents, such as in the healthcare setting, other public places, common areas of buildings, fixtures and the like. These protections on high-touch surfaces, fixtures, walls on other areas, would make transmission of viable pathogens less likely. The need for protection extends to other high-touch surfaces that are mobile, and can be transported from room-to-room and place-to-place, such as mobile device protection (antimicrobial screen protectors), keyboards, monitors and other control screens. Moreover, there is a need for articles and materials with anti-infective surfaces, such as medical devices including implants, screws, rods, pins, catheters, stents, surgical tools and the like which could prevent infections by proactively killing bacteria that attempt to colonize the device surface both pre- and post-operatively.

For biomedical patient-contacting surfaces like external fixation devices and implantable medical devices, antibiotic administration is not always effective once microbial contamination is well established as a biofilm. External fixation devices provide temporary and necessary rigid constraints to facilitate bone healing. However, patients risk pin-tract infection at the site extending from the skin-pin interface to within the bone tissue. Such complications can result in sepsis and osteomyelitis, which could require sequestrectomy for correction. Even the most stringent pin-handling and post-procedure protocols have only a limited effect. Studies have shown that such protocols do not reduce the chance of infection. Numerous medical applications, including orthopaedic, trauma, spine and general surgery applications, where the potential for infection is a serious concern, are not amenable to simple application of antiseptic or treatment with antibiotics. For example, infection can be a devastating complication of a total joint arthroplasty (TJA). While some infections may be treated by antibiotic suppression alone, more aggressive therapies, such as two-stage re-implantation, are often required. TJA infections occur when bacteria colonize the surface of the implant. These species then form a resistant biofilm on the implant surface, which nullifies the body's normal antibody response.

In minimally-invasive spine fusions, pedicle screws are first implanted in the bone of the vertebrae, and then rods are fixed into the heads of the screws to immobilize and stabilize the affected segments. Screws and rods pass through the patient's skin into the spine space via a cannulated channel. As in external fixation, screws and rods are also prone to pin-tract infections; due to the implants' pathway through the skin and points of commensal organism colonization (such as C. acnes in sebaceous glands), the chance of contacting and/or passing harmful bacteria is greatly increased. Catheters and shunts are placed in any number of body cavities and vessels to facilitate the injection, drainage or exchange of fluids. Infections are common in catheter placements and are largely dependent on how long the patient is catheterized.

In a commercial setting, the need for antimicrobial protection against organisms that impact human health an industry extends to food and beverage-contacting surfaces, such as those used for packaging, storing, shipping, and serving. Every year, food spoilage not only contributes to significant product and capital losses, but also greatly impacts human health and contributes to rising healthcare costs. Additional measures are needed to adequately control the microbes responsible.

US Patent Application Publication 2009/0104474 teaches that, for substrates that do not have readily acidifiable groups, a continuous, thin alkoxide layer that does not require a proton transfer step can be employed to functionalize the surface and allowing it to bind organic or metallic material. This continuous oxide adhesion layer, that is to say, a layer that is formed by a matrix of individual molecules that are chemically bonded and linked to each other, as opposed to individual molecules covering the surface, specifically through the application of heat. It further teaches that metal alkoxide adhesion layers bonded to substrates in a continuous layer can then be converted to a functionalized oxide layer for subsequent chemistry.

US Patent Application Publication 2010/0215643 and its continuation, granted U.S. Pat. No. 10,596,304, incorporated herein by reference in their entireties, teaches that anti-infective compounds can be covalently bonded to polymer and metal surfaces through the functional group of a phosphonic acid before attaching said acid to either a native oxide or an oxide derived from an alkoxide precursor. This application also teaches that the metal alkoxide adhesion layer is a suitable matrix for the metallization of polymers with copper through the use of copper “seed” layers that can serve as nucleation sites for copper bulk growth (Gu et al., Organic Solution Deposition of Copper Seed Layers onto Barrier Metals. Mat. Res. Soc. Symp. Proc. 2000, 612, D9.19.1-D9.19.6 (p. D9.19.2, lines 33-40; p. D9.19.5, lines 14-22)). Other functionalization processes described therein may be employed depending on the substrate to be functionalized and the anti-infective moiety desired. For example, it is possible to functionalize substrates that contain acidic protons. Such as —OH or —NH groups, by their reaction with Group IV alkoxides. This procedure yields a molecular adhesion species that is bound to the surface of the bulk polymer, but is limited to materials that have acidic groups on their surface. This method is described in detail in Dennes, T. J. et al., High Yield Activation of Scaffold Polymer Surfaces to Attach Cell Adhesion Molecules. J. Am. Chem. Soc. 2007, 129, 93-97: and Dennes, T. J.; Schwartz, J. Controlling Cell Adhesion on Polyurethanes. Soft Matter 2008, 4, 86-89, both of which are incorporated herein by reference in their entireties.

### SUMMARY OF THE DISCLOSURE

The present invention meets these needs for improved antimicrobial, antibacterial and/or antiviral metal coatings and methods that enable the production of such coatings on a variety of surfaces.

One aspect of the invention is directed to a method of forming an antimicrobial and/or antiviral metal coating on a metal substrate, comprising the steps of a) contacting an oxidized surface of a metal substrate with a metal alkoxide solution to form a metal alkoxide layer on the metal substrate surface; b) subjecting the metal alkoxide layer to conditions sufficient to form a 3-dimensional metal oxide/alkoxide adhesion layer on the metal substrate surface; c) infiltrating the 3-dimensional metal oxide/alkoxide adhesion layer with a salt solution of one or more transition metals selected from the group consisting of the transition metals of Groups 4-12 within Periods 4-5 of the periodic table; and d) reducing the transition metal salt with a reducing agent solution to form a continuous network of transition metal within the 3-dimensional metal oxide/alkoxide adhesion layer and provide a continuously adherent 3-dimensional coating; where the oxidized metal substrate is a metal comprising an oxidized surface.

The oxidized metal surface can be a native oxide surface, or a metal surface that has been prepared for treatment by oxidation. Suitable metal surface oxidation methods can include both chemical- and energy-based modifications, such as, without limitation, treatment with piranha solution, oxygen, or ozone.

Another aspect of the inventions is directed to a method of forming an antimicrobial and/or antiviral metal coating on a metal substrate, comprising the steps of a) contacting an oxidized surface of a metal substrate with a metal alkoxide solution to form a metal alkoxide layer on the metal substrate surface; b) subjecting the metal alkoxide layer to conditions sufficient to form a 3-dimensional metal oxide/alkoxide adhesion layer on the metal substrate surface; c) infiltrating the 3-dimensional metal oxide/alkoxide adhesion layer with a salt solution of a post-transition metal selected from the group consisting of aluminum, zinc, gallium, cadmium, indium and tin to form a substrate having an infiltrated adhesion layer; d) sintering the substrate having an infiltrated adhesion layer at a temperature of about 150° C. to about 550° C. to deposit the post-transition metal atoms within the 3-dimensional metal oxide/alkoxide adhesion layer thereby forming a sintered substrate; and e) electrolyzing the sintered substrate in the presence of a salt solution of one or more transition metals selected from the group consisting of the transition metals of Groups 4-12 within Periods 4-5 of the periodic table, thereby replacing the deposited post-transition metal atoms with transition metal atoms and forming a continuous transition metal network within the 3-dimensional metal oxide/alkoxide adhesion layer to provide a substrate containing a continuously adherent 3-dimensional coating; where the oxidized metal substrate is a metal comprising an oxidized surface.

The oxidized metal surface can be a native oxide surface, or a metal surface that has been prepared for treatment by oxidation.

Preferably the post-transition metal is zinc. When the post-transition metal is zinc, preferably corresponding transition metal is copper.

A further aspect of the invention is directed to a method of forming an antimicrobial and/or antiviral metal coating on a polymer surface, comprising the steps of a) contacting a surface of a polymer substrate with a metal alkoxide solution to form a metal alkoxide layer on the polymer substrate surface; b) subjecting the metal alkoxide layer to conditions sufficient to form a 3-dimensional metal oxide/alkoxide adhesion layer on the polymer substrate surface; c) infiltrating the 3-dimensional metal oxide/alkoxide adhesion layer with a salt solution of a transition metal selected from the group consisting of the transition metals of Groups 4-12 within Periods 4-5 of the periodic table; and d) reducing the transition metal salt with a reducing agent solution to form a continuous network of transition metal within the 3-dimensional metal oxide/alkoxide adhesion layer and provide a continuously adherent 3-dimensional coating; where the polymer comprises surface groups that bond to the metal alkoxide in the metal alkoxide solution to form the metal alkoxide layer.

Yet another aspect of the invention is directed to a method of forming an antimicrobial and/or antiviral metal coating on an emulsion surface, comprising the steps of: a) coating at least one surface of a substrate with a polymer emulsion film to form an exposed polymer emulsion film; b) contacting the exposed polymer emulsion film with a metal alkoxide solution to form a metal alkoxide layer on the surface of the polymer emulsion film; c) subjecting the metal alkoxide layer to conditions sufficient to form a 3-dimensional metal oxide/alkoxide adhesion layer on the polymer emulsion film surface; d) infiltrating the 3-dimensional metal oxide/alkoxide adhesion layer with a salt solution of a transition metal selected from the group consisting of the transition metals of Groups 4-12 within Periods 4-5 of the periodic table; and e) reducing the transition metal salt with a reducing agent solution to form a continuous network of transition metal within the 3-dimensional metal oxide/alkoxide adhesion layer and provide a continuously adherent 3-dimensional coating; where the emulsion polymer film comprises surface groups that bond to the metal alkoxide in the metal alkoxide solution to form the metal alkoxide layer.

Still another aspect of the invention is directed to a method of forming an antimicrobial and/or antiviral metal coating on a textile surface, comprising the steps of: a) contacting a surface of a textile substrate with a metal alkoxide solution to form a metal alkoxide layer on the textile surface; b) subjecting the metal alkoxide layer to conditions sufficient to form a 3-dimensional metal oxide/alkoxide adhesion layer on the textile substrate surface; c) infiltrating the 3-dimensional metal oxide/alkoxide adhesion layer with a salt solution a transition metal selected from the group consisting of the transition metals of Groups 4-12 within Periods 4-5 of the periodic table; and d) reducing the transition metal salt with a reducing agent solution to form a continuous network of transition metal within the 3-dimensional metal oxide/alkoxide adhesion layer and provide a continuously adherent 3-dimensional coating; where the textile substrate comprises surface groups that bond to the metal alkoxide in the metal alkoxide solution to form the metal alkoxide layer.

Preferably, the transition metal of the above methods is selected from the group consisting of Ti, V, Cr, Mn, Fe, Co, Ni, Cu, Zr, Nb, Mo, Ru, Rh, Pd and Ag. More preferably, the transition metal is copper.

Preferably, step of reducing the transition metal salt in the above methods comprises reducing the transition metal salt with a borohydride reducing agent. Preferably, the borohydride reducing agent comprises an aqueous borohydride solution.

A further aspect of the invention is directed to an antimicrobial and/or antiviral metal coating on a metal, polymer, emulsion or textile substrate prepared by the above methods.

### DETAILED DESCRIPTION

### Definitions

As disclosed herein, a number of ranges of values are provided. It is understood that each intervening value, to the tenth of the unit of the lower limit, unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included in the invention. The term “about” generally includes up to plus or minus 10% of the indicated number. For example, “about 10%” may indicate a range of 9% to 11%, and “about 20” may mean from 18 to 22. Preferably “about” includes up to plus or minus 6% of the indicated value. Alternatively, “about” includes up to plus or minus 5% of the indicated value. Other meanings of “about” may be apparent from the context, such as rounding off, so, for example “about 1” may also mean from 0.5 to 1.4.

As used herein, the term “sintering” denotes the application of thermal energy, so that a solid mass of material is formed without melting to the point of liquefaction. The term “infiltrating” denotes the ability for one chemical phase to enter or go into another. The term “reducing” denotes the ability to give electrons to another chemical structure. Suitable reducing agents include borohydrides and carbohydrates, preferably borohydrides. The term “electrolyzing” denotes the ability to use electrical energy as a driving potential in a liquid. As used herein, the phrase “conditions sufficient” denotes those experimental conditions that support the reaction.

The articles encompassed by the invention include those having surfaces likely to be colonized by microorganisms that impact human health, including human pathogens as well as other organisms such as those involved in food spoilage. Articles containing such surfaces can be deployed in a healthcare, public, or private setting.

Articles also include household articles such as cutting boards, sinks, utensils, counter tops, packaging, food storage containers, refrigerator parts, coolers, and the like.

Articles further include those deployed in businesses, hospital and/or nursing home environments such as walls, floors, bed-pans, sinks, fixtures, and woven or non-woven protective surfaces such as surgical garments, draperies, linens, bandages, wound dressings, and the like.

Articles also include high-touch surfaces in public and private environments likely to be colonized with viable organisms, such as rails, guides, handles on windows or doors, doorknobs, push panels, counter surfaces and the like.

Articles further include high-touch surfaces such as mobile device touch screens and protectors, computers, laptops, keyboards, monitors, control panel screens for healthcare equipment, and the like.

Articles also include food- and beverage-contacting surfaces, such as food and beverage packaging, storage containers, shipping containers, and the like.

Articles further include medical devices such as implantable or percutaneous medical devices. Medical devices include those used in endoscopic, arthroscopic, laparoscopic, cardiac, orthopedic, orthopedic trauma, spine, surgical, cardiovascular, and vascular procedures, such as non-woven mesh, woven mesh, foam, cloth, fabric, drainage catheters, shunts, tapes, meshes, ropes, cables, wire, sutures, skin and tissue staples, burn sheets, and those devices useful for external fixation and temporary/non-permanent implants.

In certain embodiments the article is a medical implant device or component thereof. Suitable medical implant devices and components thereof include, without limitation, orthopedic prostheses for the hip, knee, ankle, shoulder, elbow, and spine. Exemplary medical implant devices include a full or partial knee arthroplasty prosthesis, full or partial hip arthroplasty prosthesis, full or partial elbow arthroplasty prosthesis, full or partial wrist arthro-plasty prosthesis, full or partial shoulder arthroplasty prosthesis, full or partial ankle arthroplasty prosthesis, and full or partial articulating spinal segment arthroplasty prosthesis. Exemplary components of medical implant devices include a femoral component (e.g., for replacing one or more femoral condyles) or a tibial component (e.g., for replacing at least a portion of a proximal tibial plateau) of a knee prosthesis (e.g., a uni-compartmental or total knee arthroplasty prosthe-sis), a femoral component (e.g., for replacing at least the proximal portion or head of the femur) or an acetabular cup (e.g., for replacing the hip bone's femoral socket) of a hip prosthesis, a humeral component (e.g., for replacing the distal portion of the humerus) or an ulnar component (e.g., for replacing the proximal portion of the ulna) of an elbow prosthesis, a metacarpal com-ponent (for replacing at least a portion of one or more metacarpal bones) or radial component (for replacing the distal portion of the radius) of a wrist prosthesis, a humeral component (e.g., for replacing the proximal portion or head of the humerus) or glenoid component (e.g., for replacing the glenoid or socket portion of the scapula) of a shoulder prosthesis, a tibial compon-ent (e.g., for replacing the distal portion of the tibia) or talar component (e.g., for replacing the proximal portion of the talus) of an ankle prosthesis, and an endplate component (e.g., for contacting the superior or inferior portion of a cervical, lumbar or thoracic vertebra) or spacer component (e.g. for insertion between endplate components) of a vertebral disc prosthesis.

The invention is directed to methods of forming an antimicrobial and/or antiviral metal coating on a substrate surface. Various substrates are applicable depending on the desired flexibility of the article in view, and the nature of the intended use of the article. Suitable substrates include, for example, metals, polymers, emulsion coatings (e.g., painted substrates), and textiles. The substrate comprises surface groups that bond to a metal alkoxide in a metal alkoxide solution to form a metal alkoxide layer, as part of the coating process.

### Metal Substrates

In an exemplary embodiment, the present method is directed to forming a continuous copper network within a three-dimensional metal nano-matrix (metal oxide/alkoxide layer). In one example, this can be accomplished by: A) soaking a substrate comprising a 3-dimensional metal oxide/alkoxide layer in a CuSO₄ solution or spraying such a substrate with a CuSO₄ solution, followed by drying and reduction with borohydride, or B) soaking a substrate comprising a 3-dimensional metal oxide/alkoxide layer in a ZnSO₄ solution or spraying such a substrate with a ZnSO₄ solution, followed by sintering at high temperature, and thereafter electrolyzing to replace the Zn with Cu.

Method A. One aspect of the invention is directed to a method of forming an antimicrobial and/or antiviral metal coating on a metal substrate, comprising the steps of a) contacting an oxidized surface of a metal substrate with a metal alkoxide solution to form a metal alkoxide layer on the metal substrate surface; b) subjecting the metal alkoxide layer to conditions sufficient to form a 3-dimensional metal oxide/alkoxide adhesion layer on the metal substrate surface; c) infiltrating the 3-dimensional metal oxide/alkoxide adhesion layer with a salt solution of one or more transition metals selected from the group consisting of the transition metals of Groups 4-12 within Periods 4-5 of the periodic table; and d) reducing the transition metal salt with a reducing agent solution to form a continuous network of transition metal within the 3-dimensional metal oxide/alkoxide adhesion layer and provide a continuously adherent 3-dimensional coating; where the oxidized metal substrate is a metal comprising an oxidized surface.

The oxidized metal surface can be a native oxide surface, or a metal surface that has been prepared for treatment by oxidation.

Method B. Another aspect of the inventions is directed to a method of forming an antimicrobial and/or antiviral metal coating on a metal substrate, comprising the steps of a) contacting an oxidized surface of a metal substrate with a metal alkoxide solution to form a metal alkoxide layer on the metal substrate surface; b) subjecting the metal alkoxide layer to conditions sufficient to form a 3-dimensional metal oxide/alkoxide adhesion layer on the metal substrate surface; c) infiltrating the 3-dimensional metal oxide/alkoxide adhesion layer with a salt solution of a post-transition metal selected from the group consisting of aluminum, zinc, gallium, cadmium, indium and tin to form a substrate having an infiltrated adhesion layer; d) sintering the substrate having an infiltrated adhesion layer at a temperature of about 150° C. to about 550° C. to deposit the post-transition metal atoms within the 3-dimensional metal oxide/alkoxide adhesion layer thereby forming a sintered substrate; and e) electrolyzing the sintered substrate in the presence of a salt solution of one or more transition metals selected from the group consisting of the transition metals of Groups 4-12 within Periods 4-5 of the periodic table, thereby replacing the deposited post-transition metal atoms with transition metal atoms and forming a continuous transition metal network within the 3-dimensional metal oxide/alkoxide adhesion layer to provide a substrate containing a continuously adherent 3-dimensional coating; where the oxidized metal substrate is a metal comprising an oxidized surface.

The oxidized metal surface can be a native oxide surface, or a metal surface that has been prepared for treatment by oxidation.

Preferably the post-transition metal is zinc. When the post-transition metal is zinc, preferably corresponding transition metal is copper.

The metal substrates of Methods A and B can comprise a surface subject to public contact such as, for example, hand railings, guides, push panels, counters, doorknobs, door handles, and window handles.

### Polymer Substrates

Method C. A further aspect of the invention is directed to a method of forming an antimicrobial and/or antiviral metal coating on a polymer surface, comprising the steps of a) contacting a surface of a polymer substrate with a metal alkoxide solution to form a metal alkoxide layer on the polymer substrate surface; b) subjecting the metal alkoxide layer to conditions sufficient to form a 3-dimensional metal oxide/alkoxide adhesion layer on the polymer substrate surface; c) infiltrating the 3-dimensional metal oxide/alkoxide adhesion layer with a salt solution of a transition metal selected from the group consisting of the transition metals of Groups 4-12 within Periods 4-5 of the periodic table; and d) reducing the transition metal salt with a reducing agent solution to form a continuous network of transition metal within the 3-dimensional metal oxide/alkoxide adhesion layer and provide a continuously adherent 3-dimensional coating; where the polymer comprises surface groups that bond to the metal alkoxide in the metal alkoxide solution to form the metal alkoxide layer.

Suitable metal alkoxides include the alkoxides of metals selected from the oxophilic/oxyphilic transition metals. Such metals include Zr, Ti, Hf, Ta, Nb, and V. Preferably the metal alkoxide is a titanium alkoxide or zirconium alkoxide. The alkoxides are preferably ligands of the formula —O—(C(R¹)(R²))ₙ—CH₃, where n=0 to 11 and R¹ and R² are independently H or C₁- to C₃-alkyl. Preferably n=1 to 4, and R¹ and R² are independently H or CH₃. Preferably the alkoxides are the isopropoxide or t-butoxide. More preferably, the metal alkoxides are Zr(O—tBu)₄, Zr(O—iPr)₄, Ti(O—tBu)₄ or Ti(O—iPr)₄.

The polymer substrates can comprise a surface subject to public contact such as, for example, hand railings, guides, push panels, counters, doorknobs, door handles, and window handles.

### Emulsion Substrates

Method D. Yet another aspect of the invention is directed to a method of forming an antimicrobial and/or antiviral metal coating on the surface of an emulsion coating, e.g. a painted surface, comprising the steps of: a) coating at least one surface of a substrate with a polymer emulsion film to form an exposed polymer emulsion film; b) contacting the exposed polymer emulsion film with a metal alkoxide solution to form a metal alkoxide layer on the surface of the polymer emulsion film; c) subjecting the metal alkoxide layer to conditions sufficient to form a 3-dimensional metal oxide/alkoxide adhesion layer on the polymer emulsion film surface; d) infiltrating the 3-dimensional metal oxide/alkoxide adhesion layer with a salt solution of a transition metal selected from the group consisting of the transition metals of Groups 4-12 within Periods 4-5 of the periodic table; and e) reducing the transition metal salt with a reducing agent solution to form a continuous network of transition metal within the 3-dimensional metal oxide/alkoxide adhesion layer and provide a continuously adherent 3-dimensional coating; where the emulsion polymer film comprises surface groups that bond to the metal alkoxide in the metal alkoxide solution to form the metal alkoxide layer.

Further, the emulsion coating can be a coating of paint, preferably comprising TiO₂. The paint coating can be fresh or old, for example over a month old, or over a year old.

### Textile Substrates

Method E. Still another aspect of the invention is directed to a method of forming an antimicrobial and/or antiviral metal coating on a textile surface, comprising the steps of: a) contacting a surface of a textile substrate with a metal alkoxide solution to form a metal alkoxide layer on the textile surface; b) subjecting the metal alkoxide layer to conditions sufficient to form a 3-dimensional metal oxide/alkoxide adhesion layer on the textile substrate surface; c) infiltrating the 3-dimensional metal oxide/alkoxide adhesion layer with a salt solution of a transition metal selected from the group consisting of the transition metals of Groups 4-12 within Periods 4-5 of the periodic table; and d) reducing the transition metal salt with a reducing agent solution to form a continuous network of transition metal within the 3-dimensional metal oxide/alkoxide adhesion layer and provide a continuously adherent 3-dimensional coating; where the textile substrate comprises surface groups that bond to the metal alkoxide in the metal alkoxide solution to form the metal alkoxide layer. The conditions sufficient to form a 3-dimensional metal oxide/alkoxide adhesion layer on the textile substrate surface, step b), include heating below the degradation point of the textile, typically up to about 75° C. to about 90° C.

In one embodiment, the transition metal of any of any of Methods A-E is selected from Ti, V, Cr, Mn, Fe, Co, Ni, Cu, Zr, Nb, Mo, Ru, Rh, Pd and Ag. Alternatively the transition metal is selected from the oxophilic/oxyphilic transition metals, including Zr, Ti, Hf, Ta, Nb, and V. In another embodiment, the transition metal is copper.

In one embodiment, the step of reducing the transition metal salt in Methods A, C, D and E, comprises reducing the transition metal salt with a borohydride reducing agent. In another embodiment, the borohydride reducing agent comprises an aqueous borohydride solution. Suitable borohydrides include sodium borohydride, ammonium borohydride, lithium borohydride, aluminum borohydride, beryllium borohydride, uranium borohydride, and related borohydrides such as L-Selectride®, lithium triethylborohydride, sodium triethylborohydride, sodium cyanoborohydride, and sodium triacetoxyborohydride.

A further aspect of the invention is directed to an antimicrobial and/or antiviral metal coating on a metal substrate, prepared by Methods A or B.

Another aspect of the invention is directed to an antimicrobial and/or antiviral metal coating on a polymer, emulsion or textile substrate, prepared by Methods C, D or E.

Textile products suitable for antimicrobial/antiviral metal coating include:
1) Medical textiles for wear, including but not limited to scrubs, coats, disposable and washable masks and other PPE;
2) Medical textiles for use, including but not limited to drapes, linens, towels and cloths, medical braces (including hook and loop components), narrow fabrics as used in products such as medical adhesives and tape;
3) Devices using textiles or monofilaments, such as sutures;
4) Military textiles for wear or use, such as but not limited to uniforms and accessories such as badges, footwear, gear such as weather-protection wear (ponchos, raincoats and the like), tents, backpacks and utility belts, PPE, cords, ropes and cables, straps and sheaths;
5) Recreational textiles for wear or use, including but not limited to clothing, accessories, footwear, backpacks, tents;
6) Household, office, and hospitality textiles, including but not limited to linens (sheets, tablecloths, napkins, etc.), bathroom/gym/spa fabrics such as towels, robes and body wraps;
7) Upholstery, including, but not limited to, that used in furniture and vehicles;
8) Industrial textiles, including but not limited to textiles and filaments used in filter and sieving components for ductwork and other industrial applications, monofilaments such as those found in conveyer belts, cords, ropes and cables.

Yet another aspect of the invention is directed to a kit for forming an antimicrobial and/or antiviral metal coating on a substrate. The kit comprises one or more containers of metal alkoxide solution; one or more containers of transition metal salt solution; and optionally, one or more containers of reducing agent solution. The kit of claim can further comprise a container of a post-transition metal salt solution. Preferably the containers are spray bottles or spray cans. Preferably the metal alkoxide solution is a solution of a titanium alkoxide or zirconium alkoxide in toluene or isopropanol. Preferably the transition metal salt solution is aqueous Cu(II) sulfate. Preferably the reducing agent solution is sodium borohydride in aqueous ethanol. Preferably the post-transition metal salt solution is aqueous Zn(II) acetate.

### EXAMPLES

The following examples are intended to be illustrative of the present invention, and in no way limit its scope.

### General Procedures

Examples of three-dimensional metal nano matrices of titanium, zirconium, and stainless steel were prepared on coupons of metal/polymer/textile sheet or on disks of metal cut from billet, a polymer solid or la larger textile piece (defined here are materials). Surface roughness by means of natural metal surface finish, coarse or spherical media blasting, laser abrasion, micropatterning, nanopatterning, can also serve as potential three-dimensional matrices. As noted, titanium or zirconium alkoxide is dissolved in toluene and materials are dipped in solution for some time. Additionally the metal alkoxide, for example, titanium or zirconium alkoxide, is dissolved in isopropanol, spraying of the solution onto the target metal oxide, hydroxylated polymer, or hydroxylated textile. Where noted, aerosol application was carried out either in the ambient environment by spraying solution of the alkoxide, for example, from a pump-spray bottle, or application was made in a glove box containing the materials.

Another method to deliver a titanium matrix is to use titanium dioxide-based paint on a surface and allow it to dry. Metal surfaces were painted with titanium dioxide-based paint, for example by using a brush. Painted surfaces were allowed to dry by regular room air flow. The alkoxide solution can be applied to this emulsion surface.

The metal surfaces (e.g., titanium (CP) stainless steel (316L, 304)) are cleaned by several detergent sonication steps and using various solvents like water, reagent alcohol, ethanol, etc. A more stringent cleaning method can be applied such as piranha cleaning, oxygen plasma cleaning by setting up the cleaning using 20-200 watts, constant flow of high purity grade oxygen and times ranging from 5 minutes to 10 hours.

The materials are dipped in a solution of toluene or isopropanol containing an alkoxide. Materials dipped in the alkoxide solution are left in solution as little as 5 minutes and up to 15 minutes. Materials are lifted from solution at a constant rate of 3 mm/min until all materials are out of solution. The solvent is evaporated from the materials at room temperature or with gentle heating, optionally in the presence of an inert gas current, for example, nitrogen flowing over the surface. Alternatively the solvent is left to evaporate to the ambient environment after spraying a solution of alkoxide in toluene or isopropanol, for example from a pump-spray bottle. Where noted, solvent evaporation is carried out in the ambient environment, or under an inert atmosphere, for example, in a glove box. The materials, depending on the composition and substrate, are transferred to a 100° C. oven and annealed for up to 30 minutes. Another variation is to anneal titanium or zirconium on materials with known resistivity after these materials are pulled out of the alkoxide solution at 3 mm/min. Thus alkoxide-coated materials are connected to an electric source, for example, at 100 volts, to raise the temperature of the object, like a heating element. This anneals the titanium alkoxide and/or zirconium alkoxide to the metal oxide. After the voltage is set to zero, materials can cool at room temperature.

### Example 1. Formation of Continuous Copper Compounds within Interstices of Three-Dimensional Titanium and Zirconium Nano-Matrices on Metal and Textile Materials

The titanium alkoxide and zirconium alkoxide treated materials were dipped in a 200 mM aqueous copper(II) sulfate solution for 6-12 hours at room temperature during which time the salt infiltrates the 3-dimensional metal oxide/alkoxide adhesion layer. Thereafter, the copper(II) sulfate soaked materials are held in a 1M aqueous (dimethylamino) borane solution for 3-6 hours at 50° C. to reduce the intercalated Cu(2+) to Cu(0). Another variation of the reaction is to spray or paint the 200 mM copper(II) sulfate solution and allow it to dry on the surface by active air flow, gentle nitrogen stream flowing over the surface, or by mild heating on a heating block between 40-50° C. After the copper(II) sulfate was dried, 1M sodium borohydride solution in 70% ethanol (in deionized (DI) water) was sprayed on the surface to reduce the dried copper(II) sulfate to elemental copper within 10 seconds to up to 5 minutes. Thereafter, materials were rinsed copiously with DI water, followed by a reagent alcohol rinse. Samples were dried over a stream of nitrogen gas, and vacuum dried below 900 millitorr. As a last step, samples were heated at 25 to 200° C. for 2 hours or more. After heating, materials were sonicated for 15 minutes in deionized water, followed by 15 minutes in reagent alcohol sonication, and dried over a stream of nitrogen gas, vacuum dried below 900 millitorr.

### Example 2. Formation of Continuous Elemental Copper within the Interstices of Zinc Coated Three-dimensional Metal Nano-Matrices using Copper Electroplating

Substrates coated with three-dimensional metal oxide/alkoxide matrices were dipped in a 200 mM aqueous zinc(II) acetate solution for 12 hours at room temperature. Thereafter, the zinc infiltrated three-dimensional metal oxide/alkoxide matrix-coated substrates were dipped in a 0.1 mM aqueous sodium hydroxide solution for 6 hours at room temperature. The substrates were rinsed with water and sintered at 500° C. for 12 hours to deposit zinc (0) within the 3-dimensional metal oxide/alkoxide adhesion layer. Following sintering, the treated substrates were cooled to room temperature. Finally, sintered substrate was connected to an anode, and an elemental copper plate was connected to a cathode and dipped in a 200 mM aqueous copper(II) sulfate conductive solution. An electric current at a constant 10 volts was applied though the circuit to begin copper electroplating onto the zinc coated materials. After electroplating, the substrates were rinsed with water followed by a water/reagent alcohol sonication for 10 minutes. Samples were vacuum dried to 250 millitorr.

### Example 3. Antimicrobial Efficacy

Stainless steel strips prepared as in Example 1 were cut into 1×1 cm squares, sanitized with 70% reagent alcohol, and dried with inert gas. The sanitized samples were aseptically transferred individually into the wells of a sterile 24-well polystyrene dish. An overnight Escherichia coli (E. coli) ATCC 25404 culture was diluted in ASTM E2149 working buffer to 1-4E+06 CFU/mL, confirmed by plating a sample of the working culture onto solid nutrient media. The samples were submerged in this working culture, and subjected to dynamic contact (i.e. shaking on an orbital shaker) at 37° C. for 18±2 hours. After the contact period, samples of buffer from each well were removed, serially diluted, and plated onto rich solid media agar plates. The agar plates were incubated overnight at 37° C. until visible colonies formed. Colonies were enumerated, and the number of colonies recovered from treated samples was compared to the number recovered from control (untreated samples) in order to give a value of percent CFU/mL reduction relative to the control. Treated coupons reduced the E. coli CFU/mL by 6.2 logs versus control samples.

### Example 4. Antiviral Efficacy

1×3 inch stainless steel strips prepared as in Example 1 were assessed for antiviral activity against SARS-CoV-2, the causal agent of COVID-19 infections. Antiviral activity was assessed via the 50% tissue culture infectious dose (TCID50) assay in Vero E6 monkey kidney cells. Neat viral inoculum, corresponding to roughly 1-2E+06 particles, was dried onto the surface of both treated and untreated samples. Viral particles were recovered at Time 0, 30, and 60 minutes post-drying. Recovered particles were resuspended in DMEM, and serially diluted 1:10 in DMEM. Each viral dilution was used to infect the Vero E6 cells, and cell cultures were assessed for signs of cytopathic effect (CPE) at 4 and 5 days as a measure of infectious dose. The viral titer was determined by the inverse of the last dilution found to inhibit viral infection (i.e. lack of observed CPE). There was a ≥99%, ≥98.29%, and ≥98.86% reduction in infectious particles that had been exposed to treated surfaces, versus controls, at 0, 30, and 60 minutes, respectively.

### Preliminary Antimicrobial Data

TABLE 1
Log efficacy copper treated stainless steel against E. coli at different CFU challenge and time points. The dried
drop method is a closer representation of real droplet deposition on surfaces after coughing or sneezing.

| Test Method | Stainless Steel 304 | Cu-Stainless Steel 304 | Log 10 |
|---|---|---|---|
| E. coli Challenge | (Total CFU) | (Total CFU) | Reduction |
| ASTM-2149 | Buffer: 1.7E+6 ± 8.8E+4 | Buffer: 0.0 ± 0.0 | Buffer: 6.2 Logs |
| (18 hours) | Surface: 7.2E+2 ± 3.1E+2 | Surface: 0.0 ± 0.0 | Surface: 2.8 Logs |
| Dry Drop Method | 8.0E+3 ± 5.8E+2 | 0.0 ± 0.0 | 3.9 Logs |
| (30 minutes) | | | |
| Dried Drop Method | 4.5E+3 ± 5.8E+2 | 0.0 ± 0.0 | 3.6 Logs |
| (15 minutes) | | | |
| Dried Drop Method | 4.7E+4 ± 1.6E+4 | 0.0 ± 0.0 | 4.7 Logs |
| (15 minutes) | | | |

TABLE 2
Log efficacy copper-treated titanium dioxide painted stainless steel against E. coli using ASTM 2149.

| Test Method | Stainless Steel 304 | Cu/Titanium Base-Painted | Log 10 |
|---|---|---|---|
| E. coli Challenge | (Total CFU) | Stainless Steel 304 | Reduction |
| ASTM-2149 | Buffer: 4.4E+6 ± 1.9E+5 | Buffer: 0.0 ± 0.0 | Buffer: 6.6 Logs |
| (18 hours) | Surface: 1.93E+3 ± | Surface: 0.0 ± 0.0 | Surface: 3.3 Logs |
| | 4.3E+2 | | |

### Example 5. Copper Treatment of Textiles by Nanolayering, General Method

In the process described below, nanolayering is used to fill the internal structure of textiles to form long-lasting antimicrobial textiles. The layering process places a layer of titanium oxide/alkoxide on the textile surface followed by infiltrating with copper (II) sulfate, and finally reduction of the copper (II) ions to elemental copper or copper oxide species. The layering process was repeated several times in order to fill a percentage of the available internal structure of the fabric. Conceptually, the process uses the internal 3-dimensional structure of the textile to i) increase the payload of copper nanoparticles (copper loading magnitude) and ii) to combine the inherent 3-dimensional structure of the textile and titanium layering to minimize the release of the elemental copper/copper oxide nanoparticles/copper ions (copper temporal release) out of a finite-thickness textile construct. Thus, the combined geometry of the textile and the titanium layering increases the average path length and loading of the copper species in the antimicrobial textile construct. Layering increases copper loading and reduces its release from the antimicrobial construct under various physical conditions such as washing, friction, stretching, and compression.

Thus, the antimicrobial textile construct further defines a geometric progression property where there is a constant between the total number of cleaning/abrasion cycles and the total number of layers that will support bactericidal and bacteriostatic properties. It was observed that further addition of layers non-linearly increases the constant, which is indirect evidence of the increasing loading and average length path in the antimicrobial textile construct. It was found that for nylon a single layer supports bactericidal/bacteriostatic properties up to 2 wash cycles (constant value=2) and adding a second layer extends the bactericidal/bacteriostatic properties up to 9 wash cycles (constant value=4.5). However, the constant appears to be textile dependent. Thus, cotton at a constant value of 4.5 showed more bactericidal activity than either nylon or polyester at a comparable number of washes and number of layers.

The following examples apply the layering process to three textile materials with different chemical signatures and 3-dimensional structures. In addition, antimicrobial data indirectly supports the control of copper nanoparticle release from the construct when putting the copper treated textile through repetitive washing cycles in an anionic detergent and deionized water. After the wash cycles, the ability of the textile to inhibit/attenuate bacteria was tested using supraphysiological growth conditions. The assay involved measuring absorbance at 600 nm wavelength to determine bacterial cell growth at different time points, after 18 hours incubation of the textile between two layers of nutrient-rich agar.

### Example 6. Copper Coating of Woven Nylon Fabric

Woven nylon fabric (CORDURA™) was treated on the non-hydrophobic side of the fabric. The following steps describe one layer of treatment on a piece of textile material:

A 1% titanium (IV) butoxide solution in isopropanol was sprayed onto the non-hydrophobic side of the nylon fabric using a fine mist TLC sprayer. Thereafter, pressure was applied using a room temperature iron for 1-2 minutes. Then, hot pressure was applied at a temperature range of 75-90° C. for 1-5 minutes. After hot pressing the 1% titanium (IV) butoxide solution, the samples were exposed to water vapor for 10 minutes. Following, a fine mist of aqueous 200 mM copper (II) sulfate solution was sprayed onto the fabric, followed with hot pressure at a temperature range of 75-90° C. for 1-5 minutes. As a last step a solution of 0.001M sodium borohydride was sprayed on the surface using a fine mist TLC sprayer. After reduction, the samples were soaked in a large volume of DI water for 20 minutes, for a total of two rinse steps. The procedure was optionally repeated to add additional treatment layers, and was then followed by a post-treatment wash step. Besides the regular DI water wash post-treatment, samples were washed using a solution of 0.055% ionic detergent (Gain™) in DI water under constant agitation (stir bar at 500 rpm) for 15 minutes. Samples were then rinsed in water three times, followed with two cycles of DI water rinsing under constant agitation (stir bar at 500 rpm). The previous washing conditions were repeated to account for multiple washing scenarios (e.g., 3, 6, 9, and 12 cycles). Samples were allowed to dry inside a chemical hood before subjecting to antimicrobial assay.

### Example 7. Two Copper Coating Layers on Woven Nylon Fabric

In one embodiment, two Cu nanolayers were added to the woven nylon fabric according to the procedure of Example 6. Treated samples were washed for 3, 6 and 9 cycles. Bacteriostatic/bactericidal assessment was performed using methicillin-sensitive Staphylococcus aureus (MSSA)in nutrient rich conditions with measurement of absorbance at 600 nm. The untreated nylon control showed dramatic MSSA cell growth over the course of 5 hours. In contrast Cu-nylon 3/2 (2 Cu nanolayers, 3 wash cycles) and Cu-nylon 6/2 (2 Cu nanolayers, 6 wash cycles) showed no cell growth over 5 hours. Cu-nylon 9/2, which had been subjected to 9 wash cycles, showed some MSSA cell growth over 5 hours. This indicates good wash-resistance of the Cu treatment on woven nylon fabric.

### Example 8. Copper Coating of Polyester/Nylon Fabric

Commercial sportswear polyester/nylon fabric was treated using the same steps as for Example 6. A 1% titanium (IV) butoxide solution in isopropanol was sprayed on the polyester/nylon fabric using a fine mist TLC sprayer. Following, pressure was applied using a room temperature iron for 1-2 minutes. Then, hot pressure was applied at a temperature range of 75-90° C. for 1-5 minutes. After hot pressing the 1% titanium (IV) butoxide solution, the samples were exposed to water vapor for 10 minutes. Thereafter, a fine mist of aqueous 200 mM copper (II) sulfate solution was sprayed on the fabric, followed with hot pressure at 75-90° C. for 1-5 minutes. As a last step, a solution of 0.001M sodium borohydride was sprayed on the surface using a fine mist TLC sprayer. After reduction reaction, the samples were soaked in a large volume of DI water for 20 minutes, for a total of two rinses. This sequence of steps was optionally repeated to add more Cu treatment layers, and then followed by a post-treatment wash step. Besides the regular DI water wash post-treatment, samples were washed using a 0.055% ionic detergent (Gain™) solution in DI water under constant agitation (stir bar at 500 rpm) for 15 minutes. Samples were then rinsed in water three times, followed with two cycles of DI water rinsing under constant agitation (stir bar at 500 rpm). The previous washing conditions were repeated to account for multiple washing scenarios (e.g., 3, 6, 9, and 12 cycles). Samples were allowed to dry inside the chemical hood before subjecting to the antimicrobial assay.

### Example 9. Two Copper Coating Layers on Polyester/Nylon Fabric

In one embodiment, two nanolayers of Cu treatment were added to the polyester/nylon fabric according to the procedure of Example 8, followed by bacteriostatic/bactericidal assessment using MSSA in nutrient rich conditions, as described above. Treated samples were washed for 3, 6 and 9 cycles. The untreated polyester/nylon control showed dramatic MSSA cell growth over the course of 3 hours by measurement of the optical density at 600 nm. In contrast, Cu-polyester/nylon 3/2 showed almost no cell growth over 3 hours. Cu-polyester/nylon 6/2 and Cu-polyester/nylon 9/2, which had been subjected to 6 and 9 wash cycles respectively, showed intermediate levels of MSSA cell growth over 3 hours, with the coated fabric washed 9 times evidencing more MSSA cell growth than the coated fabric washed only 6 times. This indicates some wash-resistance of the Cu nanolayers on polyester/nylon fabric.

### Example 10. Copper Coating of Woven Cotton Fabric

Commercial woven cotton fabric was treated using the same steps as for Examples 6 and 8. A 1% titanium (IV) butoxide solution in isopropanol was sprayed onto the cotton fabric using a fine mist TLC sprayer. Following, pressure was applied using a room temperature iron for 1-2 minutes. Then, hot pressure was applied at a temperature range of 75-90° C. for 1-5 minutes. After hot pressing the 1% titanium (IV) butoxide solution, the samples were exposed to water vapor for 10 minutes. Following, a fine mist of aqueous 200 mM copper (II) sulfate solution was sprayed on the fabric, followed with hot pressure at 75-90° C. for 1-5 minutes. As a final step, a solution of 0.001M sodium borohydride was sprayed on the surface using a fine mist TLC sprayer. After reduction reaction, the samples were soaked in a large volume of DI water for 20 minutes, for a total of two rinses. This sequence of steps was optionally repeated to add more Cu treatment layers, and then followed by a post-treatment wash step. Besides the regular DI water wash post-treatment, samples were washed using a 0.055% ionic detergent (Gain™) solution in DI water under constant agitation (stir bar at 500 rpm) for 15 minutes. Samples were rinsed in water three times, followed with two cycles of DI water rinsing under constant agitation (stir bar at 500 rpm). The previous washing conditions were repeated to account for several washing scenarios (e.g., 3, 6, 9, and 12 cycles). Samples were allowed to dry inside the chemical hood before subjecting to the antimicrobial assay.

### Example 11. Two Copper Coating Layers on Cotton Fabric

In one embodiment, two nanolayers of Cu treatment were added to the cotton fabric according to the procedure of Example 10, followed by bacteriostatic/bactericidal assessment using MSSA in nutrient rich conditions, as described above. Treated samples were washed for 3, 6 and 9 cycles. The untreated cotton control showed dramatic MSSA cell growth over the course of 5 hours, by measurement of the optical density at 600 nm. In contrast, all three of the treated samples (Cu-cotton 3/2, Cu-cotton 6/2 and Cu-cotton 9/2) showed no cell growth over the course of 5 hours, indicating the excellent wash-resistant nature of the Cu treatment on woven cotton fabric.

It will be understood by those of skill in the art that numerous and various modifications can be made without departing from the spirit of the present invention. Therefore, it should be clearly understood that the various embodiments of the present invention described herein are illustrative only and are not intended to limit the scope of the present invention.

1. A method of forming an antimicrobial and/or antiviral metal coating on a metal substrate, comprising the steps of:
a) contacting an oxidized surface of a metal substrate with a metal alkoxide solution to form a metal alkoxide layer on the metal substrate surface;
b) subjecting the metal alkoxide layer to conditions sufficient to form a 3-dimensional metal oxide/alkoxide adhesion layer on the metal substrate surface;
c) infiltrating said 3-dimensional metal oxide/alkoxide adhesion layer with a salt solution of one or more transition metals selected from the group consisting of the transition metals of Groups 4-12 within Periods 4 and 5 of the periodic table; and
d) reducing said transition metal salt with a reducing agent solution to form a continuous network of transition metal within said 3-dimensional metal oxide/alkoxide adhesion layer and provide a continuously adherent 3-dimensional coating;
wherein said oxidized metal substrate is a metal comprising an oxidized surface.

2. A method of forming an antimicrobial and/or antiviral metal coating on a metal substrate, comprising the steps of:
a) contacting an oxidized surface of a metal substrate with a metal alkoxide solution to form a metal alkoxide layer on the metal substrate surface;
b) subjecting the metal alkoxide layer to conditions sufficient to form a 3-dimensional metal oxide/alkoxide adhesion layer on the metal substrate surface;
c) infiltrating said 3-dimensional metal oxide/alkoxide adhesion layer with a salt solution of a post-transition metal selected from the group consisting of aluminum, zinc, gallium, cadmium, indium and tin to form a substrate having an infiltrated adhesion layer;
d) sintering said substrate having an infiltrated adhesion layer at a temperature of about 150° C. to about 550° C. to deposit the post-transition metal atoms within the 3-dimensional metal oxide/alkoxide adhesion layer thereby forming a sintered substrate; and
e) electrolyzing said sintered substrate in the presence of a salt solution of one or more transition metals selected from the group consisting of the transition metals of Groups 4-12 within Periods 4 and 5 of the periodic table, thereby replacing the deposited post-transition metal atoms with transition metal atoms and forming a continuous transition metal network within said 3-dimensional metal oxide/alkoxide adhesion layer to provide a substrate containing a continuously adherent 3-dimensional coating;
wherein said oxidized metal substrate is a metal comprising an oxidized surface.

3. The method of claim 1, wherein said oxidized surface is a native oxide surface.

4. A method of forming an antimicrobial and/or antiviral metal coating on a polymer surface, comprising the steps of:
a) contacting a surface of a polymer substrate with a metal alkoxide solution to form a metal alkoxide layer on the polymer substrate surface;
b) subjecting the metal alkoxide layer to conditions sufficient to form a 3-dimensional metal oxide/alkoxide adhesion layer on the polymer substrate surface;
c) infiltrating said 3-dimensional metal oxide/alkoxide adhesion layer with a salt solution of a transition metal selected from the group consisting of the transition metals of Groups 4-12 within Periods 4 and 5 of the periodic table; and
d) reducing said transition metal salt with a reducing agent solution to form a continuous network of transition metal within said 3-dimensional metal oxide/alkoxide adhesion layer and provide a continuously adherent 3-dimensional coating;
wherein said polymer comprises surface groups that bond to the metal alkoxide in the metal alkoxide solution to form said metal alkoxide layer.

5. A method of forming an antimicrobial and/or antiviral metal coating on an emulsion surface, comprising the steps of:
a) coating at least one surface of a substrate with a polymer emulsion film to form an exposed polymer emulsion film;
b) contacting the exposed polymer emulsion film with a metal alkoxide solution to form a metal alkoxide layer on the surface of the polymer emulsion film;
c) subjecting the metal alkoxide layer to conditions sufficient to form a 3-dimensional metal oxide/alkoxide adhesion layer on the polymer emulsion film surface;
d) infiltrating said 3-dimensional metal oxide/alkoxide adhesion layer with a salt solution of a transition metal selected from the group consisting of the transition metals of Groups 4-12 within Periods 4 and 5 of the periodic table; and
e) reducing said transition metal salt with a reducing agent solution to form a continuous network of transition metal within said 3-dimensional metal oxide/alkoxide adhesion layer and provide a continuously adherent 3-dimensional coating;
wherein said emulsion polymer film comprises surface groups that bond to the metal alkoxide in the metal alkoxide solution to form said metal alkoxide layer.

6. A method of forming an antimicrobial and/or antiviral metal coating on a textile surface, comprising the steps of:
a) contacting a surface of a textile substrate with a metal alkoxide solution to form a metal alkoxide layer on the textile surface;
b) subjecting the metal alkoxide layer to conditions sufficient to form a 3-dimensional metal oxide/alkoxide adhesion layer on the textile substrate surface;
c) infiltrating said 3-dimensional metal oxide/alkoxide adhesion layer with a salt solution a transition metal selected from the group consisting of the transition metals of Groups 4-12 within Periods 4 and 5 of the periodic table; and
d) reducing said transition metal salt with a reducing agent solution to form a continuous network of transition metal within said 3-dimensional metal oxide/alkoxide adhesion layer and provide a continuously adherent 3-dimensional coating;
wherein said textile substrate comprises surface groups that bond to the metal alkoxide in the metal alkoxide solution to form said metal alkoxide layer.

7. The method of claim 1, wherein the transition metal is selected from the group consisting of Ti, V, Cr, Mn, Fe, Co, Ni, Cu, Zr, Nb, Mo, Ru, Rh, Pd and Ag.

8. The method of claim 7, wherein the transition metal is copper.

9. The method of claim 2, wherein the post-transition metal is zinc.

10. The method of claim 9, wherein the transition metal is copper.

11. The method of claim 1, wherein said step of reducing said transition metal salt comprises reducing said transition metal salt with a borohydride reducing agent.

12. The method of claim 11, wherein said borohydride reducing agent comprises an aqueous borohydride solution.

13. The method of claim 1, wherein said transition metal is copper.

14. The method of claim 1, wherein the oxidized metal surface is a native oxide, or a metal surface that has been prepared for treatment by oxidation.

15. An antimicrobial and/or antiviral metal coating on a metal substrate prepared by the method of claim 1.

16. An antimicrobial and/or antiviral metal coating on a substrate prepared by the method of claim 4.

17. The method of claim 5, wherein said polymer emulsion film is a paint coating.

18. The method of claim 17, wherein said paint coating is over a month old.

19. The method of claim 17, wherein said paint coating is over a year old.

20-23. (canceled)

24. A kit for forming an antimicrobial and/or antiviral metal coating on a substrate, said kit comprising:
one or more containers of metal alkoxide solution;
one or more containers of transition metal salt solution; and
optionally, one or more containers of reducing agent solution.

25-30. (canceled)
